(19) United States
(12) Patent Application Publication
(10) Pub. No.: US 2026/0368022 A1
(43) Pub. Date: Nov. 19, 2026

(54) WORKFLOW SUMMARIZER

(71) Applicant: ServiceNow, Inc., Santa Clara, CA (US)

(72) Inventors: Venu Vajjala, Hyderabad (IN); Poonam Agrawal, Hyderabad (IN); Revanth Chowdary, Hyderabad (IN); Magesh Narayanan, Redmond, WA (US)

(21) Appl. No.: 19/207,827

(22) Filed: May 14, 2025

(51) Int. Cl. G06F 11/07; G06Q 10/0633

(52) U.S. Cl. CPC G06F 11/079; G06F 11/0709; G06Q 10/0633

(57) ABSTRACT

Embodiments of the subject technology relate to systems, methods, and computer-readable media summarizing a failed workflow. A workflow comprising a plurality of steps arranged in an order can be obtained An instance of the workflow can be executed and an occurrence of a failure can be detected in the instance of the workflow. A particular step in the plurality of steps that is associated with the failure can be identified. One or more particular substeps of a particular subflow that caused the failure can be identified. A summary of only the one or more particular substeps can be generated through a generative model. The summary can be indicative of a cause of the failure of the workflow.

### BACKGROUND

### 1. Technical Field

The present disclosure generally relates to summarizing a failed workflow, and more specifically to summarizing a workflow through a generative model based on a subset of the substeps in the failed workflow.

### 2. Introduction

Workflows have been developed that serve as a structured framework for visualizing and executing business processes. Specifically, workflows have been developed that outline steps to follow in achieving an objective in response to a specific occurrence. In modern information technology (IT) environments, for example, incidents such as system failures, and service disruptions are frequently encountered. In turn, workflows can be used in responding to the incidents. Workflows can fail in achieving the objective or meeting the objective in a desired manner. As workflows grow in complexity, it becomes more difficult to troubleshoot a failed workflow.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a schematic diagram of an architecture for summarizing a workflow, according to some examples of the present disclosure;

FIG. 3 illustrates a schematic diagram of a failed workflow, according to some examples of the present disclosure;

FIG. 4 illustrates a flowchart of an example method of generating a summary of a failed workflow based on a portion of the workflow, according to some examples of the present disclosure;

FIG. 5 illustrates a flowchart of an example method of identifying substeps associated with a workflow failure and summarizing the substeps in a cascading manner through an order of the workflow, according to some examples of the present disclosure;

FIG. 6 illustrates a flowchart of an example method of summarizing portions of a failed workflow through cascading summarization and then summarizing the overall workflow through recursive summarization, according to some examples of the present disclosure;

FIG. 7 is an example of a deep learning neural network that can be used to implement all or a portion of the systems and techniques described herein, according to some examples of the present disclosure;

FIG. 8 is a diagram illustrating an example architecture of an example transformer model, according to some examples of the present disclosure; and

FIG. 9 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Workflows have been developed that serve as a structured framework for visualizing and executing business processes. Specifically, workflows have been developed that outline steps to follow in achieving an objective in response to a specific occurrence. In modern information technology (IT) environments, for example, incidents such as system failures, and service disruptions are frequently encountered. In turn, workflows can be used in responding to the incidents. Workflows can fail in achieving the objective or meeting the objective in a desired manner. As workflows grow in complexity, it becomes more difficult to troubleshoot a failed workflow.

Workflows have grown in complexity and become nested in nature. Specifically, many workflows are complex involving a parent workflow and multiple subworkflows/subflows arranged in a hierarchy/order. The complexity and hierarchical nature of workflows can make trouble shooting workflows extremely difficult. For example, a workflow failure can be caused by a failure in a subworkflow in a fifth hierarchical layer of the workflow. The failure in the subworkflow can then cause failures in the parent workflow and subworkflows in the hierarchical levels above the workflow. In turn, the hierarchical nature of the workflow and the spanning of the failures across multiple levels can make it difficult for an operator to trouble shoot the workflow to determine the root cause of the failure. Specifically, an operator can expend a great amount of resources in tracing down the parent workflow and subworkflows in each hierarchical level to find a root cause of the workflow failure. Similarly, the hierarchical nature of the workflow and the spanning of the failure across multiple levels can make it difficult to automate troubleshooting the workflow. A large amount of computational resources can be expended in analyzing the parent workflow and the subworkflows in each hierarchical level to find the failing point in a subworkflow of the workflow.

The disclosed technology addresses the foregoing by identifying a root substep of a subworkflow that caused failure in a workflow by analyzing a subset of the total subworkflows and substeps. Specifically, subflows and substeps that have failed in a hierarchy of a workflow can be analyzed on a cascading basis while ignoring other subworkflows and substeps in the hierarchy. More specifically, failed substeps can be followed down the hierarchy based on whether the substeps failed because of a failed substep at a lower level in the hierarchy. This process can be repeated until a substep is reached that did not fail because of a failed substep at a lower level in the hierarchy, otherwise is the root substep that caused the failure. As follows, execution of the failed root substep can be analyzed/summarized to determine the actual cause of the failure in the substep. A subworkflow can comprise a single substep or multiple substeps.

Summarizing a failed workflow with multiple subworkflows, steps, and substeps can be resource intensive, from both an operator perspective and a computational perspective. Specifically, a generative model can realize a max-token limit in trying to summarize the entire failed workflow. Further, workflows are non-standardized and can be defined and generated across different entities using different nomenclature, syntax, and semantics. In turn, this can lead to inaccuracies in summarizing the different workflows. When attempting to summarize a failed workflow that fails due to a substep buried deep in a hierarchy, it becomes more difficult to set forth or adequately describe, in an overall summary, the failed substep or the reasons for the substep failure.

The disclosed technology addresses the foregoing by generating a summary of a failed workflow with multiple subworkflows and corresponding substeps based on summaries of only a subset of the subworkflows and substeps in the workflow, e.g. recursive summarization. Specifically, the previously described techniques can be implemented to identify subworkflows in the workflow that are relevant to the overall failure of the workflow, e.g. subworkflows and corresponding substeps that have failed. The subworkflows that are identified can be summarized and used in generating an overall summary of the workflow. As a result, the summary can be generated using fewer tokens while still highlighting and summarizing the reasons for the failure that are buried deep in a hierarchy of the workflow. Further, as the overall summary can be more accurate as there is less data to incorporate into the summary, as compared to a summary that is generated from a summary of every step and subworkflow in the workflow.

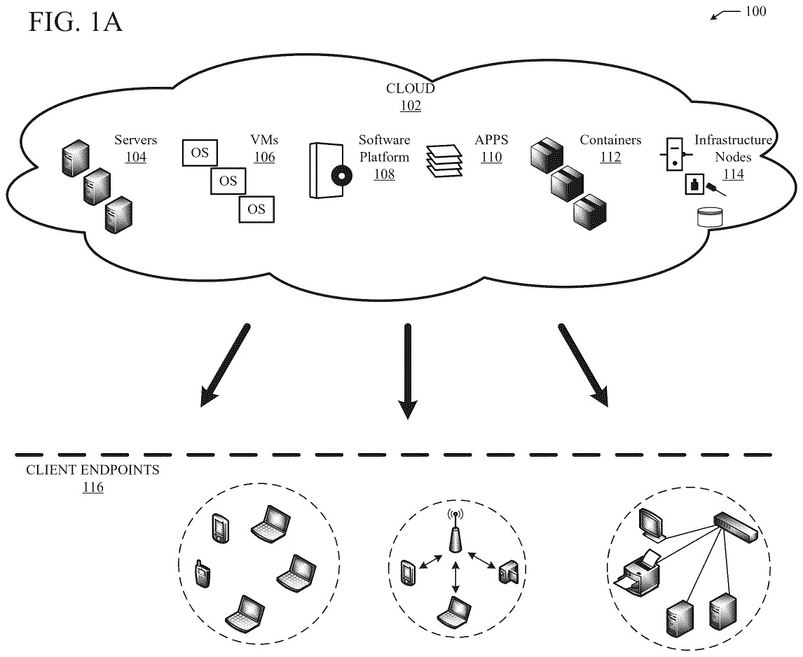

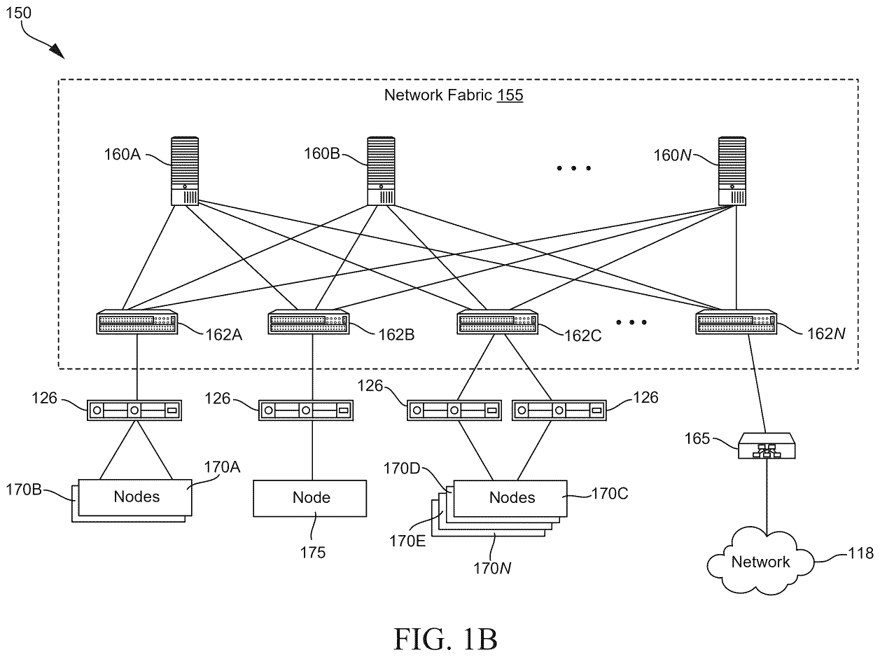

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (Saas) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IOT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes. In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B. In particular, machine learning (ML) models and large language models (LLMs) and other applicable models and applications can be implemented through the architectures 100 and 150.

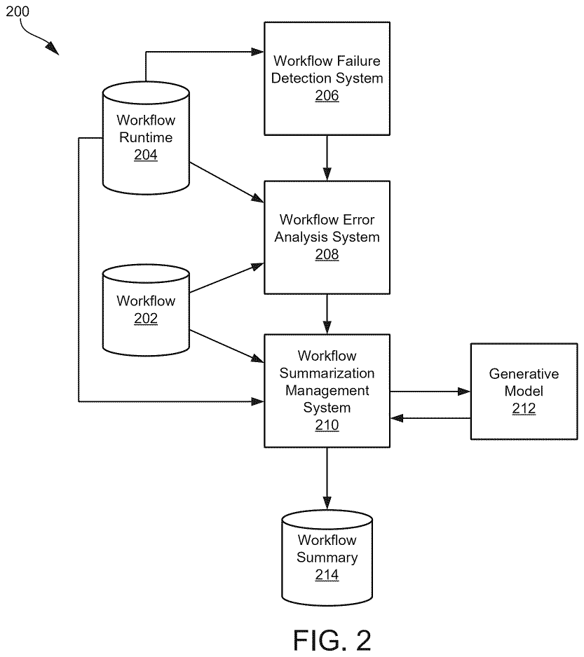

FIG. 2 illustrates a schematic diagram of an architecture 200 for summarizing a workflow, according to some examples of the present disclosure. The architecture 200 comprises a workflow datastore 202, a workflow runtime datastore 204, a workflow failure detection system 206, a workflow error analysis system 208, a workflow summarization management system 210, a generative model 212, and a workflow summary datastore 214.

The workflow datastore 202 functions to store data describing or otherwise used in implementing a workflow. A workflow, as used herein, can comprise specific sequences or series of tasks, processes, and/or actions to perform in achieving respective goal(s)/objective(s). For example, a flow can include a trigger(s) and an action(s), and can optionally include flow logic. The trigger(s) can define when to initiate the action(s), and the action(s) can include any task, function, operation, step, and/or process to implement for the flow.

As workflows grow in complexity, they have become more nested in nature. Specifically, a workflow can comprise one or more subflows that can be executed during the course of executing the workflow. One or more subflows at the beginning of the workflow, e.g. in a hierarchy, can be referred to as the parent workflow. A subflow, as used herein, can be a distinct workflow that can be triggered and executed as an activity of a parent workflow. As follows, the parent workflow can pause until the subflow completes, or fails, before continuing, or trying to continue, execution. A subflow, can comprise one or more respective triggers, one or more respective actions, and can optionally include any flow logic.

A workflow can comprise a plurality of different steps. The steps can comprise one or more actions/activities that are performed in executing the workflow. A step can comprise one or more subflows. For example, a step in the workflow can comprise a specific subflow that is executed in executing the workflow. A step in the workflow can comprise substeps that form the step. Specifically, the substeps can be executed in performing the step in the workflow. With respect to when the step comprises the subflow, substeps of the step can be substeps in the subflow. Substeps of a subflow can comprise actions that are performed in performing the subflow. The substeps can each correspond to a specific action or multiple actions of the subflow.

A workflow can be associated with or have an order/hierarchy that serves as an arrangement of steps and subflows of the workflow. The order can define a way in which subflows, steps, and substeps are executed in the workflow. An order can include different branches that can be executed in executing the workflow. The branches can comprise steps, subflows, and substeps. Further, different branches of the workflow can be executed in parallel or in series.

A workflow can comprise an automated action. An automated action can comprise an action that is capable of being performed/is performed by a system other than a human operator in executing the workflow. For example, an automated action can be performed by an agent in executing the workflow in attempting to achieve an objective. Further, a workbook can comprise a manual action. A manual action can comprise an action that is capable of being performed/is performed by a human operator in executing a workflow. Automated and manual actions can be trigger-specific actions that form part of a stage/workflow in a hierarchical structure of a workflow.

A workflow can fail in relation to execution of the workflow. A failed workflow, as used herein, can include a workflow that fails to achieve its objective, or is performed in a manner that is different from the manner defined by the steps of the workflow. A workflow can fail due to a failure of a component or part of the workflow. For example, a workflow can fail due to one or more failed subflows, steps, or substeps. In various embodiments a subflow, step, or substep in a workflow can fail due to a failed subflow, step, or substep beneath it in the workflow order.

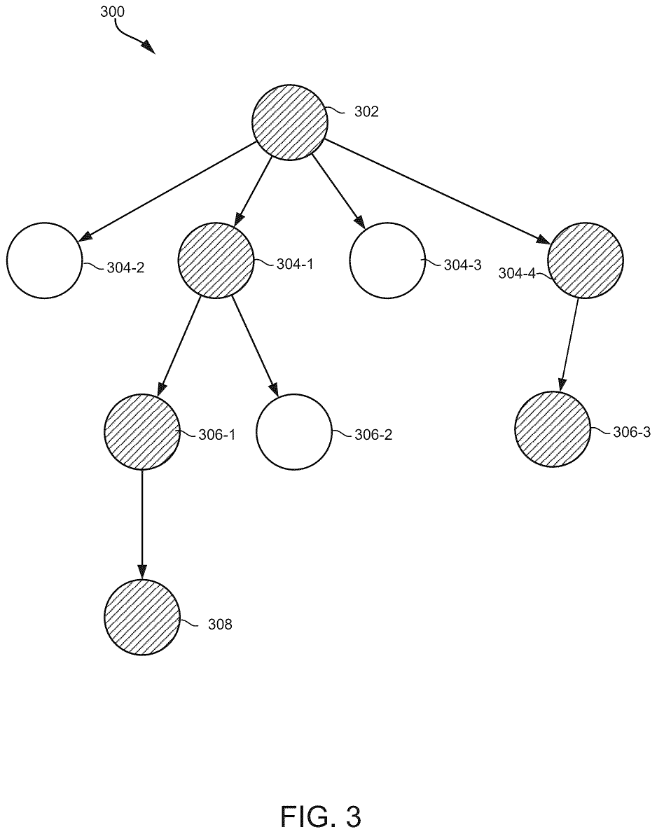

FIG. 3 illustrates a schematic diagram of a failed workflow 300, according to some examples of the present disclosure. The workflow 300 comprises a first node 302 at a first hierarchical level, and four steps 304-1, 304-2, 304-3, and 304-4 collectively referred to as “steps 304” at a second hierarchical level. Each of the steps 304 can form a subflow or part of a subflow. Further each of the steps 304 can comprise one or more substeps. In the example workflow 300 shown in FIG. 3, under step 304-2 is three substeps 306-1, 306-2, and 308 and under step 304-4 is substep 306-3. Substep 308 is under substep 306-1. While there are described as substeps, in various embodiments the substeps 306-1, 306-2, 306-3, and 308 can form steps or subflows. The workflow 300 comprises a parent workflow. The parent workflow can include or otherwise be formed by the first node 302.

The workflow 300 shown in FIG. 3 is a failed workflow. Specifically, the failed elements of the workflow 300 are represented as shaded elements while the functioning elements are represented as unshaded elements. As shown in FIG. 3, the first node 302, step 304-1, substep 306-1, and substep 308 have all failed. Additionally, step 304-4 and substep 306-3. Within these chains of failed elements are elements that are the root of the failure. Specifically, an element can fail because of a failed element beneath the element. In the workflow 300, the first node 302 can fail due to the failed step 304-1 beneath it. Step 304-1 can fail because of the failed substep 306-1 beneath it. As follows, substep 306-1 can fail because of the failed substep 308 beneath it. Failed substep 308 can either not have any elements beneath it in the workflow 300 or have additional elements beneath it in the workflow 300. In various embodiments, if there are no elements beneath the failed substep 308, then the substep 308 failed due to its own internal failure. In that scenario, the substep 308 can be characterized as the root node that caused the failure. In various embodiments, if there is an element beneath the failed substep 308 and that element has not failed, then the substep 308 did not fail because of a failed element beneath it. In that scenario, the substep 308 can be characterized as the root node that caused the failure. Similarly, the first node 302 can also fail due to the failed step 304-4. As follows, step 304-4 can fail because of failed substep 306-3. Failed 306-3 can be the root of the failure in the chain of nodes that includes node 302, step 304-4, and substep 306-3. As follows, the failures of both substeps 306-3 and 308 can be boiled to the top of the order, or otherwise identified as the reasons why node 302/the primary workflow failed.

Returning back to the architecture 200 shown in FIG. 2, the workflow runtime datastore 204 functions to store data related to running the workflow, e.g. an instance of the workflow. Execution data stored in the workflow runtime datastore 204 can include applicable data describing an execution of the workflow. For example, execution data can describe a status of subflows, steps, and substeps that are executed in the workflow, error messages that are generated during execution of the subflows, steps, and substeps, string based variables between instances of actions/activities performed in executing the workflow, a log of data that is generated in relation to execution of the workflow, and data that is generated and used in the execution of the workflow, such as values of variables that can be accessed by executing activities.

The workflow failure detection system 206 functions to detect a failure of an executed workflow and/or a currently running workflow. The workflow failure detection system 206 can detect the failure based on execution data of the workflow stored in the workflow runtime datastore 204. Specifically, the workflow failure detection system 206 can analyze execution data for the workflow either after the workflow has executed or while the workflow is executing to determine whether the workflow has failed. The workflow failure detection system 206 can implement an applicable technique for detecting workflow failure based on execution data of the workflow. For example, the workflow failure detection system 206 can scan the execution data to detect the presence of error messages that are generated during the course of executing the workflow. In another example, the workflow failure detection system 206 can scan the execution data to detect whether steps, substeps, and subflows in the workflow did not complete or otherwise execute properly.

The workflow error analysis system 208 functions to identify what nodes in the workflow failed. Specifically, the workflow error analysis system 208 can identify what nodes failed in the workflow based on execution data of the workflow stored in the workflow runtime datastore 204. For example and referring to the workflow 300 shown in FIG. 3, the workflow error analysis system 208 can identify that the first node 302, step 304-1, substep 306-1 and substep 308 have all failed based on execution data for an instance of the workflow 300.

In identifying what nodes have failed in the workflow, the workflow error analysis system 208 can analyze the nodes from the top down. Specifically, the workflow error analysis system 208 can analyzes the nodes from the top down through the order of the workflow until the workflow error analysis system 208 discovers the root node that caused the failure in the workflow. In analyzing whether a node has failed, the workflow error analysis system 208 can analyze nodes that are connected to a failed node. Specifically, the workflow error analysis system 208 can start at the parent node that has failed and iterate down the workflow, in a cascading manner, analyzing nodes that are connected to a failed node. For example, and with reference to the workflow 300, the workflow error analysis system 208 can first determine that the first node 302 of the workflow 300 has failed. Then the workflow error analysis system 208 can proceed to the next level and analyze all of the steps 304 that are connected to the first node 302. In doing so, the workflow error analysis system 208 can determine that step 304-1 has failed. As follows, the workflow error analysis system 208 can analyze substep 306-1 and substep 306-2 that are connected to step 304-1 to determine which nodes have failed. In doing so, the workflow error analysis system 208 can determine that substep 306-1 has failed. As follows, the workflow error analysis system 208 can analyze substep 308 and determine that it has failed. The workflow error analysis system 208 can continue to perform this cascading analysis until the workflow error analysis system 208 reaches the bottom of the workflow. Further, the workflow error analysis system 208 can continue to perform this cascading analysis until the workflow error analysis system 208 finds the root node, e.g. a node that does not have a failed node underneath it in the order of the workflow. The workflow error analysis system 208 can perform the same cascading analysis down the chain of nodes formed by step 304-4 and substep 306-3.

The workflow summarization management system 210 functions to manage summarization of the workflow in relation to the failure of the workflow. In managing summarization of the workflow, the workflow summarization management system 210 can facilitate summarization of the workflow. Specifically, the workflow summarization management system 210 can function with the generative model 212 to generate a summary of the workflow. The generative model 212 can comprise an applicable generative model that is configured to summarize a workflow based on a log of execution of the workflow and/or output from execution of the workflow. Specifically, the generative model 212 can comprise a large language model (“LLM”) that is configured to summarize the workflow based on runtime data of the workflow.

The workflow summarization management system 210 can facilitate, through the generative model 212, summarization of only a portion of the workflow in relation to the workflow failure. By refraining from summarizing the workflow in its entirety, the workflow summarization management system 210 can conserve resources, e.g. computational resources, that would otherwise be used in summarizing the workflow. Specifically, and as will be discussed in greater detail later, the generative model 212 can have a token limit that defines the maximum number of tokens the generative model 212 can process in a single operation, such as workflow summarization. Limiting an amount of the workflow that the generative model 212 summarizes can help to ensure that the token limit of the generative model 212 is not reached. Further and as will be discussed in greater detail later, limiting the amount of the workflow that the generative model 212 summarizes can facilitate the generative model 212 providing a more accurate summary of portions of the workflow that are summarized.

In summarizing the workflow, the generative model 212 can be provided, e.g. by the workflow summarization management system 210, or otherwise have access to the workflow data stored in the workflow datastore 202 and workflow runtime data stored in the workflow runtime datastore 204. In turn, the generative model 212 can use the data to infer a summary of a step, a substep, a subflow, or a parent flow of the workflow. Additionally, in functioning with the generative model 212 to summarize the workflow, the workflow summarization management system 210 can generate prompts that the generative model 212 can follow in summarizing the workflow. Specifically, the workflow summarization management system 210 can generate a prompt instructing the generative model 212 to summarize a step, substep, or subflow of the workflow in a cascading manner through the hierarchy of the workflow based on runtime data of the workflow. For example, the prompt can specify to scan the runtime data of a step, substep, or subflow to identify/infer an error message from the runtime data. In another example, the prompt can specify to determine whether a node, e.g. step, substep, subflow, or parent flow, failed due to a child node, e.g. node, substep, subflow, or parent flow beneath the node. Further in the example, the prompt can specify that if the node failed due to the child node, then summarize the error at the node based on failure of the child node. Still further in the example, the prompt can specify that if the node did not fail due to the child node, then summarize the error at the node by scanning the runtime data of the node.

The workflow summarization management system 210 can facilitate summarization of the workflow based on the parts of the workflow associated with the workflow failure. Specifically, the workflow summarization management system 210 can facilitate summarization of the workflow based on the parts of the workflow that contributed to the failure of the workflow, as determined by the workflow error analysis system 208. For example and with reference to the workflow shown in FIG. 3, the workflow summarization management system 210 can cause the generative model 212 to infer a summary of the failed parts of the workflow 300 comprising the first node 302, step 304-1, substep 306-1, and substep 308. In turn, the workflow summarization management system 210 can refrain from summarizing step 304-2, step 304-3, step 304-4, and substep 306-2.

The workflow summarization management system 210 can summarize the workflow based on a parent workflow/node in the workflow. Specifically, the workflow summarization management system 210 can function with the generative model 212 to summarize all or portions of the parent workflow/node irrespective of whether the portions of the parent workflow failed. More specifically, a parent workflow can comprise steps that did not fail due to a failed root node underneath the steps in the hierarchy of the workflow. As follows, the workflow summarization management system 210 can still facilitate summarization of the steps even though the steps did not fail. In facilitating summarization of only a portion of the parent workflow, the workflow summarization management system 210 can prompt the generative model 212 to summarize key steps. Key steps can be identified by the generative model 212 itself, e.g. from the workflow data and the workflow runtime data. A step can be key if it is needed for achieving the objective of the workflow, is part of a bottleneck where the workflow is inefficient or slow, has a defined role that is greater than other steps of the workflow, or based on another applicable metric that can quantify the value or importance of a step in a workflow. A prompt that is used by the generative model 212 in summarizing the parent workflow, e.g. based on key steps, can be distinct from a prompt that is used in summarizing the failed steps, subflows and substeps down the order of the workflow in a cascading manner.

The generative model 212 can be configured to access external knowledgebases in summarizing the workflow. Specifically, the generative model 212 can access applicable knowledge base articles, historical data of past applications of workflows applied to resolve incidents, and past instances of failed workflow contexts to aid in summarizing the workflow. For example, the generative model 212 can detect that an error has occurred in a substep of the workflow but fail to determine the type of error or summarize the error for the runtime data of the workflow. The generative model 212 can query past instances of failed workflows to try to match the substep to substep(s) in the past instances. As follows, the generative model 212 can use matching substeps to summarize and characterize the error of the substep in the current workflow instance.

The workflow summarization management system 210 can combine the various summaries that are created by the generative model 212 for the workflow to create an overall summary of the workflow. Specifically, the workflow summarization management system 210 can combine the summary of the parent workflow with the cascading summary of the failed nodes, subflows, steps, and substeps in the workflow. The workflow summarization management system 210 can maintain a summary of the workflow as workflow summary data stored in the workflow summary datastore 214.

Various operations can be performed based on the summarized workflow in the workflow summary datastore. For example, the workflow summary can be display to a user e.g. through a dialog box. In turn, the summary of the workflow can be used to debug failures, get the current status of executing contexts, and other applicable tasks. Further, a user can copy the summary. Additionally, the workflow summary datastore 214 can be accessed through a scriptable API so that the workflow summary can be integrated in applicable features that facilitate summarizing the workflow or use the workflow summary.

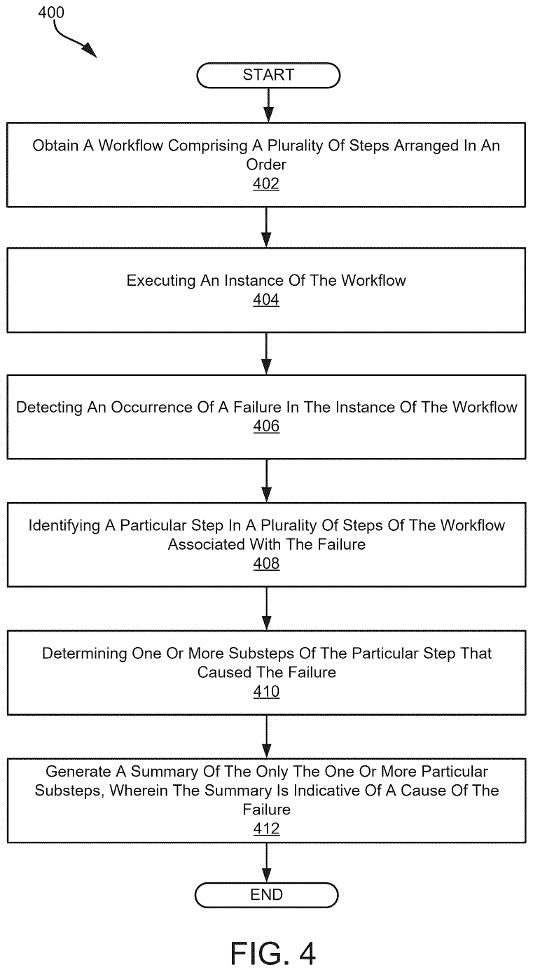

The disclosure now continues with a discussion of generating a summary of a failed workflow. Specifically, FIG. 4 illustrates a flowchart 400 of an example method of generating a summary of a failed workflow based on a portion of the workflow, according to some examples of the present disclosure. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example architectures described herein.

At module 402, a workflow comprising a plurality of steps arranged in an order is obtained. Specifically, the workflow can comprise a parent workflow and a plurality of subflows that form the steps arranged in the order. The workflow can be generated by an applicable system for generating a workflow. Specifically, the workflow can be generated by a system that allows a user to create and automate multi-step workflows. More specifically, the workflow can be generated by a system that allows a user to create a workflow without needing to write scripts for the workflow.

At module 404, an instance of the workflow is executed. The workflow can be estimated in an automated or a semi-automated manner. For example, some steps of the workflow can be executed manually by an operator while other steps of the workflow can be executed autonomously, e.g. by an agent. In executing the instance of the workflow, runtime workflow data can be generated. The runtime data can comprise a log of an output result of executing the various steps in the workflow.

At module 406, an occurrence of a failure of the instance of the workflow is detected. The failure of the workflow can be detected through an applicable technique. The failure can extend through at least a portion of the order of the workflow. For example, the failure can be caused by a root step, substep, or subflow buried deep in the order of the workflow. The failure at the root step can cause failure in the workflow to cascade up through steps, substeps, and subflows in the order until it reaches the top parent flow of the workflow. As follows, the parent flow of the workflow can fail due to the root failure step buried deep in the workflow. This hierarchical nature of the workflow and the spanning of the failures across multiple levels can make it difficult for an operator to trouble shoot the workflow to determine the root cause of the failure.

At module 408, a particular step in a plurality of steps of the workflow associated with the failure is identified. The step in the plurality of steps of the workflow that are associated with the failure can include a step that has failed because of the root failure step/substep buried deep in the workflow. Specifically, the step can be buried deep in the workflow and comprise the root failure substep. More specifically, the step can be identified by cascading down the steps and substeps of the workflow that have failed based on whether the steps and substeps have failed due to a lower substep in the order of the workflow. In various embodiments, the step that is associated with the failure can be identified without analyzing every step in the workflow. Specifically, the step can be identified by cascading down the steps of the workflow from the parent workflow of the workflow based on step failure.

At module 410, one or more substeps of the particular step that caused the failure are determined. Specifically, the one or more substeps of the particular step that caused the failure, otherwise the root substeps, can be identified by cascading down the substeps of the step based on whether the substeps have failed due to a failed substep underneath the substeps in the step. In cascading down the substeps of the step, not all of the substeps can be analyzed when the order of substeps of the step comprises parallel branches. Identifying the step, at module 408, that is associated with the failure without analyzing all of the steps of the workflow is technically advantageous as computational resources that would otherwise be spent in analyzing every step can be conserved. Similarly, identifying the substep(s), at module 410, that are associated with the failure without analyzing all of the substeps of the step is technically advantageous as computational resources that would otherwise be spent in analyzing every substep can be conserved.

At module 412, a summary of the only one or more particular substeps identified at module 410 is generated. The summary is indicative of the failure of the workflow. The summary can be generated by an applicable generative model, such as an LLM. Further, the summary can be generated based on runtime data of the failed workflow instance and workflow data describing the workflow. The summary can be generated based on whether the substeps failed on their own or whether the substeps failed due to an underlying failed substep. For example, if a first substep failed because of a second substep beneath the first substep, then the first substep can be summarized as failing because of a subsequent substep in the order of the workflow. Alternatively, if the first substep failed on its own and not because of the second substep, then the first substep can be summarized as failing for a specific reason. In particular, the LLM can check an output of the first substep included in the runtime data of the workflow to determine an error message, otherwise a reason why the first substep failed. As follows, the LLM can summarize the first substep and include the identified reason why the first substep failed in the summary.

The one or more particular substeps that are indicative of the failure of the workflow can be summarized without summarizing all of the substeps in either or both the step and the workflow. As follows, only a subset of the total steps of the workflow can be summarized in various embodiments. Summarizing only a subset of the steps and substeps of the workflow to indicate the root cause of the failure is technically advantageous as computational resources that would be spent in summarizing the entire workflow can be conserved. In particular, and as will be discussed in greater detail later, summarizing only a subset of the steps and substeps of the workflow can reduce the likelihood of reaching a token limit of a generative model that infers the summary.

As workflows become more nested and grow in complexity, it becomes more difficult for an operator to interpret a summary of an entire workflow to troubleshoot the workflow. Specifically, it can be difficult for the operator to identify the failure point(s) of the workflow and determine solutions for correcting the failure points from a summary of the entire workflow. Generating a summary of a workflow, and in particular, generating a summary based on a subset of the steps, substeps, and subflows in the workflow is technically advantageous as an operator can more quickly identify a failure point in the workflow from the condensed summary of the workflow. In turn, the operator can more easily identify steps for correcting the failed workflow from the condensed summary.

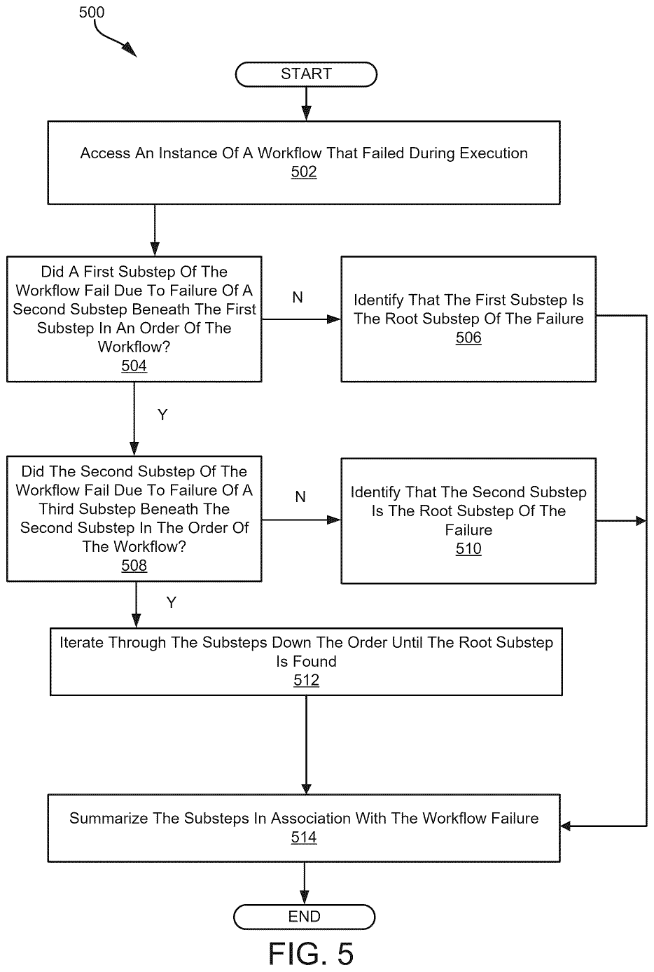

The disclosure now continues with a more detailed description of identifying substeps associated with a workflow failure and summarizing the substeps. FIG. 5 illustrates a flowchart 500 of an example method of identifying substeps associated with a workflow failure and summarizing the substeps in a cascading manner through an order of the workflow, according to some examples of the present disclosure. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method. The modules will be discussed with respect to the example architectures described herein.

At module 502, an instance of a workflow that failed during execution is accessed. Specifically, an instance of a workflow that failed during execution can be detected. In turn, runtime data for the workflow instance and workflow data for the workflow can be accessed.

At decision point 504, it is determined whether a first substep of the workflow failed due to failure of a second substep beneath the first substep in an order of the workflow. Specifically, either or both the workflow data and the runtime data for the workflow instance can be analyzed to determine whether the first substep failed due to failure of the second substep beneath the first substep. The first substep can be a substep underneath a failed parent workflow. Specifically, the error in the failed workflow can cascade up through the failed first substep to the parent workflow. In analyzing whether the first substep failed due to the second substep, the workflow data of the workflow can be analyzed to identify the second substep beneath the first substep. Further, the runtime data for the instance of the workflow can be analyzed to determine why the first substep and/or the second substep failed. Specifically, the runtime data can be analyzed, e. g by a generative model such as an LLM, to extract error messages for the first and/or second substeps. The error messages can be indicative of whether the first substep failed due to a failure within the first substep or failed due to the second substep beneath the first substep.

If it is determined at decision point 504 that the first substep did not fail due to failure of a substep beneath the first substep, then the flowchart 500 continues to module 506, where the first substep is identified as the root substep of the failure. Specifically, if it is determined that the first substep failed due to a failure within the first substep and not due to a failure of the second substep, then the flowchart 500 continues to module 506, wherein the first substep is identified as the root substep of the failure. If the first substep if identified as the root substep of the failure, then then flowchart can continue to module 514, where the substeps associated with the failure, including the first substep, are summarized, e.g. in a cascading manner. As follows, the flowchart 500 can end without proceeding to analyzing whether the second substep and subsequent substeps in the order of the workflow are the root substep of the failure.

If it is determined at decision point 504 that the first substep failed due to failure of a second substep beneath the first substep, then the flowchart 500 continues to decision point 508. At decision point 508, it is determined whether the second substep of the workflow failed due to failure of a third substep beneath the second substep in the order of the workflow. Similar to decision point 504, the workflow data of the workflow can be analyzed to identify the third substep beneath the second substep. Further, the runtime data for the instance of the workflow can be analyzed to determine why the second substep and/or the third substep failed. If it is determined at decision point 508 that the second substep did not fail due to failure of the third substep beneath the second substep, then the flowchart 500 continues to module 510, where the second substep is identified as the root substep of the failure. Specifically, if it is determined at decision point 508 that the second substep failed due to a failure within the second substep, then the flowchart 500 continues to module 510, where the second substep is identified as the root substep of the failure

If it is determined at decision point 508 that the second substep failed due to failure of a third substep beneath the second substep, then the flowchart 500 continues to module 512. At module 512, the substeps after the second substep in the order are iterated through until the root substep is found. Specifically, the substeps can be iterated through down the order of the workflow in a cascading manner until a substep is found where the error at the substep was caused by the substep itself, e.g. as a root substep of the failure, and not a substep beneath the substep. In iterating through the substeps, the runtime data can be analyzed to determine whether each of the substeps failed dues to a substep beneath it or failed due an internal failure, e.g. the substep is the root of the workflow failure.

Once the root substep is found, then the flowchart 500 continues to module 514, where the substeps that are analyzed in association with the failure of the workflow are substeps. Specifically, the substep that is identified as the root of the failure can be summarized. Further, the failed substeps that are analyzed in the cascading manner at decision point 504, decision point 508, and module 512 and are not identified as the root substep can be summarized. The substeps can be summarized from the bottom up, e.g. as part of the cascading summarization. Specifically, the root substep can be summarized and then the order of failed substeps can be followed back up to the parent workflow while summarizing each failed and analyzed substep on the way to the top parent workflow. The summarization of the substeps can be performed without summarizing every step, subflow, and substep in the workflow. Summarizing the substeps in a cascading manner based on association with the workflow failure instead of summarizing every substep in the workflow is technically advantageous in the savings of computational resources. As follows, the accuracy of the summarization, when performed by a generative model, can be improved as the generative model has to analyze less data to generate the summary, as opposed to if the model had to analyze data and infer a summary for every step/substep in the workflow.

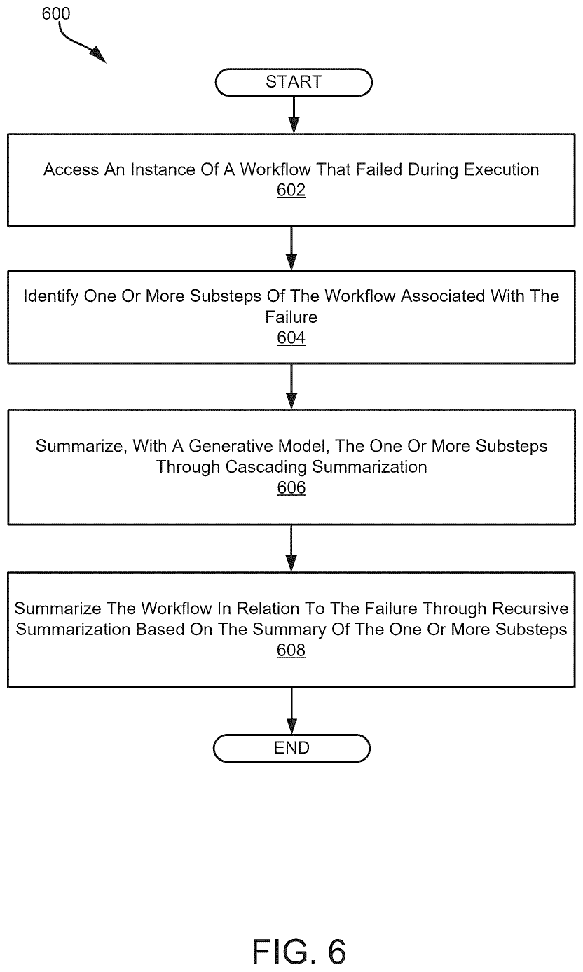

The description now continues with a discussion of summarizing a failed workflow based on recursive summarization. Specifically, FIG. 6 illustrates a flowchart 600 of an example method of summarizing portions of a failed workflow through cascading summarization and then summarizing the overall workflow through recursive summarization, according to some examples of the present disclosure. The method shown in FIG. 6 is provided by way of example, as there are a variety of ways to carry out the method. Additionally, while the example method is illustrated with a particular order of steps, those of ordinary skill in the art will appreciate that FIG. 6 and the modules shown therein can be executed in any order and can include fewer or more modules than illustrated. Each module shown in FIG. 6 represents one or more steps, processes, methods or routines in the method. The modules will be discussed with respect to the example architectures described herein.

At module 602, an instance of a workflow that failed during execution is accessed. Specifically, the instance of the workflow can be detected using an applicable technique for detecting a failed workflow. As follows, workflow data for the workflow and runtime data of the workflow instance can be accessed.

At module 604, one or more substeps of the workflow that are associated with the failure are identified. The substeps associated with the failure can comprise a substep that failed due to a failed substep beneath the substep in a hierarchy of the workflow. Further, the substeps associated with the failure can comprise a substep that failed due to a failure within the substep itself instead of a failed substep beneath the substep. The substeps can be identified by cascading down the hierarch of the workflow from the parent workflow and following the failed steps, subflows, and substeps.

At module 606, the one or more substeps are summarized with a generative model through cascading summarization. In summarizing the one or more substeps through cascading summarization, only a subset of the total substeps in the workflow can be summarized by the generative model. Specifically, the failed substeps in the workflow, including the one or more substeps, can be summarized from the root failure substep towards the top of the hierarchy and the parent workflow.

At module 608, the workflow is summarized in relation to the failure through recursive summarization. Specifically, the workflow can be summarized through recursive summarization based on the summary of the one or more substeps that is generated at module 606. Further, the workflow can be summarized based on a summary of the parent workflow. In various embodiments, only a portion of the steps/substeps of the parent workflow, e.g. the key steps, can be summarized in generating the summary of the parent workflow. Both the summary of the parent workflow and the summary of the one or more steps generated through cascading summarization at module 606 can be used generating the summary of the workflow, e.g. through the generative model. Specifically, the generative model can combine, or otherwise generate an overall summary of the workflow based on, the summary of the parent workflow and the summary of the one or more substeps associated with the failure.

In recursively summarizing the overall workflow, only portions of the one or more substeps and the parent workflow can be summarized at a time, e.g. relative to a processing limit such as a token limit of the generative model. Specifically, only portions of the summary of the one or more substeps and/or the summary of the parent workflow can be used by the generative model to generate the overall workflow summary. For example the generative model can generate the overall workflow summary on a substep-by-substep basis or step-by-step basis in a recursive manner from the summary of the one or more substeps generated at module 606.

Generating a summary of the only a subset of the substeps of the workflow through cascading summarization and recursive summarization of the subset of the substeps to generate an overall summary of the workflow can reduce the amount of data that is ultimately processed by the generative model in inferring the corresponding summaries. In turn, reducing the amount of data that is processed by the generative model is technically advantageous as the overall accuracy of the corresponding summaries can be improved. Specifically, workflows are not standardized and are therefore defined in different formats depending on the creators of the workflows. This makes it difficult for a generative model to accurately create summaries across different workflows, in particular as the workflows grow in complexity. Therefore, reducing the amount of data that the generative model processes in inferring the respective summaries associated with the workflows can lead to improved accuracy of the summaries despite discrepancies between the workflows.

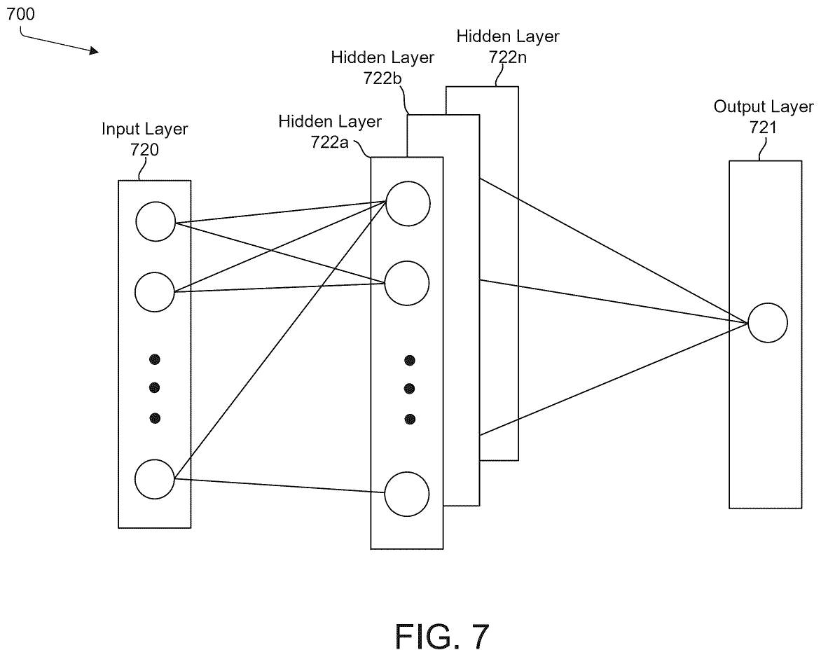

In FIG. 7, the disclosure now turns to a further discussion of models that can be used to implement the technology described herein. FIG. 7 is an example of a deep learning neural network 700 that can be used to implement all or a portion of the systems and techniques described herein, according to some examples of the present disclosure. An input layer 720 can be configured to receive input data. Neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. Neural network 700 further includes an output layer 721 that provides an output resulting from the processing performed by the hidden layers 722a, 722b, through 722n.

Neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=ρ(½ (target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

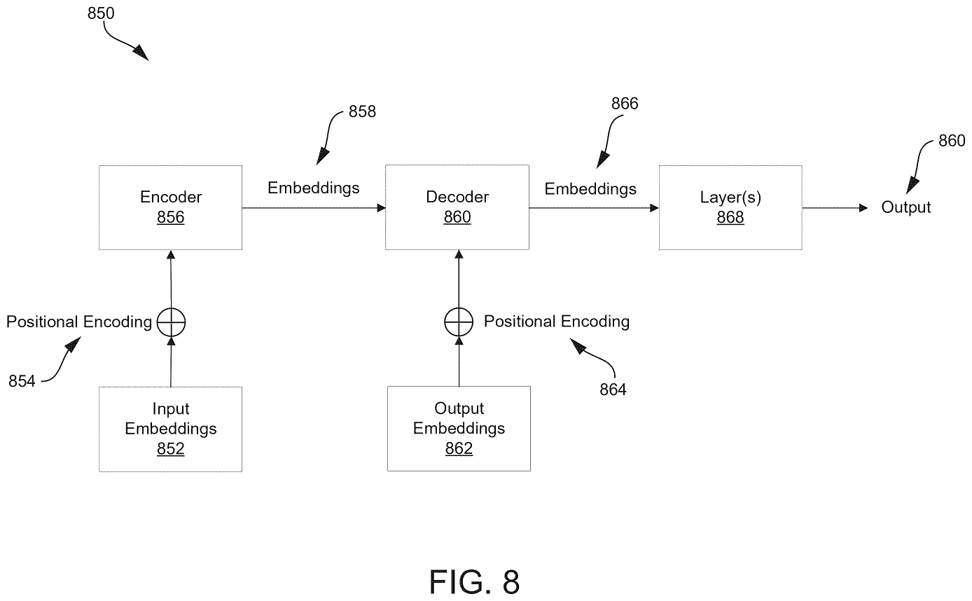

FIG. 8 is a diagram illustrating an example architecture of an example transformer model 850, according to some examples of the present disclosure. The transformer model 850 can be used to implement an LLM that can be used to implement the technology described herein. As shown, the transformer model 850 can include input embeddings 852 used as inputs to the transformer model 850. The input embeddings 852 can include input values representing words and/or sentences, such as numbers or vectors representing words and/or sentences.

In some cases, the input embeddings 852 can function like a dictionary that helps the transformer model 850 understand the meaning of words by placing them in an embedding space where similar words are located near each other. In some examples, the input interface 134 can be trained and/or configured to create the input embeddings 852 so that similar vectors represent words with similar meanings. In some examples, the transformer model 850 can additionally or alternatively learn to create and/or process the input embeddings 852 during training.

The transformer model 850 can use positional encoding 854 to encode the position of each word in an input sequence from the input embeddings 852 as values such as a set of numbers, a vector, etc. The values generated by the positional encoding 854 can be fed into the transformer model 850 along with the input embeddings 852. By incorporating the positional encoding 854 into the transformer model 850, the transformer model 850 can more effectively understand the order of words in a sentence and generate grammatically correct and semantically meaningful output.

The transformer model 850 can include an encoder(s) 856 used to process the positionally encoded input embeddings 852 and generate embeddings 858. The encoder(s) 856 can be part of the transformer model 850 that processes input text and generates hidden states that capture the meaning and context of the text. For example, the encoder(s) 856 can include a feed-forward neural network that is part of the transformer model 850. In some examples, the encoder(s) 856 can implement multiple encoder layers. In some cases, the encoder(s) 856 can first tokenize the input text into a sequence of tokens, such as individual words or subwords. The encoder(s) 856 can then apply one or more self-attention layers, which can generate hidden states that represent the input text at different levels of abstraction. In this way, the encoder(s) 856 can generate the embeddings 858 (e.g., a vector, a set of values, etc.) representing the semantics and position of words in one or more sentences.

The transformer model 850 can include output embeddings 862, which can include values representing words and/or sentences, such as numbers or vectors representing words and/or sentences. The output embeddings 862 can be similar to the input embeddings 852 and can also be processed by positional encoding 864 to encode the position of each word in a sequence from the output embeddings 862 as values such as a set of numbers, a vector, etc., which helps the transformer model 850 understand the order of words in a sentence. The output embeddings 862 can be used during a training phase of the transformer model 850 and can be used during an inference phase. During training, a loss function can be computed based on the output embeddings 862 and used to update the model parameters to improve the accuracy of the transformer model 850. During an inference phase, the output embeddings 862 can be used to generate the output text by mapping the predicted probabilities determined by the transformer model 850 for each token to the corresponding token in the vocabulary.

The positionally encoded input embeddings 852 (e.g., the embeddings 858) and the positionally encoded output embeddings 862 can be fed to a decoder(s) 860 used to generate the output sequence based on the encoded input sequence. During training, the decoder(s) 860 can learn how to guess the next word of a sequence by looking at the words before it. In some examples, the decoder(s) 860 can generate natural language text based on the input sequence and any learned context.

The decoder(s) 860 can generate embeddings 866 and feed the embeddings 866 to one or more network layers 868. In some examples, the one or more network layers 868 can include a linear layer and a softmax function. The linear layer can map the embeddings 866 generated by the decoder(s) 860 to a higher-dimensional space, which can transform the embeddings 866 into the original input space. The softmax function can then be applied to generate a probability distribution for each output token in the vocabulary, which can result in an output 870. In some examples, the output 870 can include output tokens with probabilities.

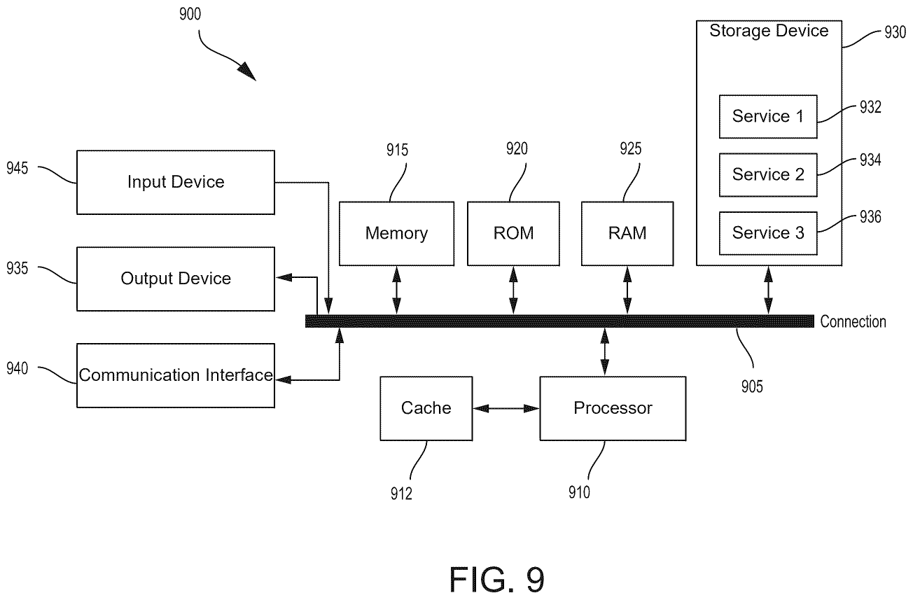

FIG. 9 illustrates an example processor-based system with which some embodiments of the subject technology can be implemented. For example, processor-based system 900 can be any computing device making up, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (Central Processing Unit (CPU) or processor) 910 and connection 905 that couples various system components including system memory 915, such as Read-Only Memory (ROM) 920 and Random-Access Memory (RAM) 925 to processor 910. Computing system 900 can include a cache of high-speed memory 912 connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 930 can include software services, servers, services, etc., that when the code that defines such software is executed by the processor 910, it causes the system 900 to perform a function. In some embodiments, a hardware service that performs a particular function can include the software component stored in a computer-readable medium in connection with the necessary hardware components, such as processor 910, connection 905, output device 935, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:

Embodiment 1. A computer-implemented method comprising: obtaining a workflow comprising a plurality of steps arranged in an order, wherein at least one step of the plurality of steps comprises a subworkflow having a plurality of substeps arranged in a suborder; executing an instance of the workflow; detecting an occurrence of a failure in the instance of the workflow; identifying a particular step in the plurality of steps of the workflow associated with the failure; determining that the particular step comprises a particular subflow; in response to determining that the particular step comprises a particular subflow, identifying one or more particular substeps of the particular subflow that caused the failure; and generating, through a generative model, a summary of only the one or more particular substeps, wherein the summary is indicative of a cause of the failure.

Embodiment 2. The computer-implemented method of Embodiment 1, wherein identifying one or more particular substeps of the particular subflow that caused the failure further comprises: determining if a first substep of the plurality of substeps failed due to failure of a second substep beneath the first substep in the particular subflow; and identifying whether the first substep is a root substep that caused the failure based on whether the first substep failed due to failure of the second substep.

Embodiment 3. The computer-implemented method of Embodiment 2, further comprising identifying that the first substep is the root substep that caused the failure if it is determined that the first substep did not fail due to failure of the second substep.

Embodiment 4. The computer-implemented method of Embodiment 3, further comprising: analyzing an output of the first substep in response to identifying that the first substep is the root substep; generating, by the generative model, a summary of the first substep based on the output of the first substep; and forming the summary of only the one or more particular substeps based on the summary of the first substep.

Embodiment 5. The computer-implemented method of any of Embodiments 2 through 4, further comprising: determining that the first substep failed due to failure of the second substep; determining if the second substep failed due to failure of a third substep beneath the second substep; and identifying whether the second substep is the root substep that caused the failure based on whether the second substep failed due to failure of the third substep.

Embodiment 6. The computer-implemented method of Embodiment 5, further comprising: generating, by the generative model, a summary of the first substep based on the first substep failing due to failure of the second substep; and forming the summary of only the one or more particular substeps based on the summary of the first substep.

Embodiment 7. The computer-implemented method of Embodiment 5, further comprising: generating, by the generative model, a summary of the first substep based on the first substep failing due to failure of the second substep; generating, by the generative model, a summary of the second substep based on whether the second substep failed due to failure of the third substep; and forming the summary of only the one or more particular substeps based on the summary of the first substep and the summary of the second substep.

Embodiment 8. The computer-implemented method of any of Embodiment 1 through 7, wherein the summary of only the one or more particular substeps comprises a description of the failure of the workflow based on a root substep that caused the failure.

Embodiment 9. The computer-implemented method of Embodiment 8, wherein the summary of only the one or more particular substeps comprises a solution for remediating the failure of the workflow.

Embodiment 10. The computer-implemented method of any of Embodiments 1 through 9, further comprising generating, through the generative model, a summary of the workflow based on the summary of only the one or more particular substeps.

Embodiment 11. The computer-implemented method of Embodiment 10, further comprising summarizing, through the generative model, the workflow based on a summary of a parent step to the particular step.

Embodiment 12. The computer-implemented method of either Embodiment 10 or 11, further comprising: recursively summarizing, through the generative model, one or more parent steps to the particular step; and generating, through the generative model, a summary of the workflow based on the summary of only the one or more particular substeps and the summaries of the one or more parent steps to the particular step.

Embodiment 13. A system comprising: one or more processors; and at least one computer-readable storage medium having stored therein instructions which, when executed by the one or more processors, cause the one or more processors to: obtain a workflow comprising a plurality of steps arranged in an order, wherein at least one step of the plurality of steps comprises a subworkflow having a plurality of substeps arranged in a suborder; execute an instance of the workflow; detect an occurrence of a failure in the instance of the workflow; identify a particular step in the plurality of steps of the workflow associated with the failure; determine that the particular step comprises a particular subflow; in response to determining that the particular step comprises a particular subflow, identify one or more particular substeps of the particular subflow that caused the failure; and generate, through a generative model, a summary of only the one or more particular substeps, wherein the summary is indicative of a cause of the failure.

Embodiment 14. The system of Embodiment 13, wherein the instructions further cause the one or more processors to: determine if a first substep of the plurality of substeps failed due to failure of a second substep beneath the first substep in the particular subflow; and identify whether the first substep is a root substep that caused the failure based on whether the first substep failed due to failure of the second substep.

Embodiment 15. The system of Embodiment 14, wherein the instructions further cause the one or more processors to identify that the first substep is the root substep that caused the failure if it is determined that the first substep did not fail due to failure of the second substep.

Embodiment 16. The system of Embodiment 15, wherein the instructions further cause the one or more processors to: analyze an output of the first substep in response to identifying that the first substep is the root substep; generate, by the generative model, a summary of the first substep based on the output of the first substep; and form the summary of only the one or more particular substeps based on the summary of the first substep.

Embodiment 17. The system of Embodiment 14, wherein the instructions further cause the one or more processors to: determine that the first substep failed due to failure of the second substep; determine if the second substep failed due to failure of a third substep beneath the second substep; and identify whether the second substep is the root substep that caused the failure based on whether the second substep failed due to failure of the third substep.

Embodiment 18. The system of Embodiment 17, wherein the instructions further cause the one or more processors to: generate, by the generative model, a summary of the first substep based on the first substep failing due to failure of the second substep; and form the summary of only the one or more particular substeps based on the summary of the first substep.

Embodiment 19. The system of any of Embodiments 13 through 18, wherein the instructions further cause the one or more processors to generate, through the generative model, a summary of the workflow based on the summary of only the one or more particular substeps.

Embodiment 20. A non-transitory computer-readable storage medium storing instructions for causing one or more processors to: obtain a workflow comprising a plurality of steps arranged in an order, wherein at least one step of the plurality of steps comprises a subworkflow having a plurality of substeps arranged in a suborder; execute an instance of the workflow; detect an occurrence of a failure in the instance of the workflow; identify a particular step in the plurality of steps of the workflow associated with the failure; determine that the particular step comprises a particular subflow; in response to determining that the particular step comprises a particular subflow, identify one or more particular substeps of the particular subflow that caused the failure; and generate, through a generative model, a summary of only the one or more particular substeps, wherein the summary is indicative of a cause of the failure.

Embodiment 21. A system comprising means for performing a method according to any of Embodiments 1 through 12.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

1. A computer-implemented method comprising:
obtaining a workflow comprising a plurality of steps arranged in an order, wherein at least one step of the plurality of steps comprises a subworkflow having a plurality of substeps arranged in a suborder;
executing an instance of the workflow;
detecting an occurrence of a failure in the instance of the workflow;
identifying a particular step in the plurality of steps of the workflow associated with the failure;
determining that the particular step comprises a particular subflow;
in response to determining that the particular step comprises a particular subflow, identifying one or more particular substeps of the particular subflow that caused the failure; and
generating, through a generative model, a summary of only the one or more particular substeps, wherein the summary is indicative of a cause of the failure.

2. The computer-implemented method of claim 1, wherein identifying one or more particular substeps of the particular subflow that caused the failure further comprises:
determining if a first substep of the plurality of substeps failed due to failure of a second substep beneath the first substep in the particular subflow; and
identifying whether the first substep is a root substep that caused the failure based on whether the first substep failed due to failure of the second substep.

3. The computer-implemented method of claim 2, further comprising identifying that the first substep is the root substep that caused the failure if it is determined that the first substep did not fail due to failure of the second substep.

4. The computer-implemented method of claim 3, further comprising:
analyzing an output of the first substep in response to identifying that the first substep is the root substep;
generating, by the generative model, a summary of the first substep based on the output of the first substep; and
forming the summary of only the one or more particular substeps based on the summary of the first substep.

5. The computer-implemented method of claim 2, further comprising:
determining that the first substep failed due to failure of the second substep;
determining if the second substep failed due to failure of a third substep beneath the second substep; and
identifying whether the second substep is the root substep that caused the failure based on whether the second substep failed due to failure of the third substep.

6. The computer-implemented method of claim 5, further comprising:
generating, by the generative model, a summary of the first substep based on the first substep failing due to failure of the second substep; and
forming the summary of only the one or more particular substeps based on the summary of the first substep.

7. The computer-implemented method of claim 5, further comprising:
generating, by the generative model, a summary of the first substep based on the first substep failing due to failure of the second substep;
generating, by the generative model, a summary of the second substep based on whether the second substep failed due to failure of the third substep; and
forming the summary of only the one or more particular substeps based on the summary of the first substep and the summary of the second substep.

8. The computer-implemented method of claim 1, wherein the summary of only the one or more particular substeps comprises a description of the failure of the workflow based on a root substep that caused the failure.

9. The computer-implemented method of claim 8, wherein the summary of only the one or more particular substeps comprises a solution for remediating the failure of the workflow.

10. The computer-implemented method of claim 1, further comprising generating, through the generative model, a summary of the workflow based on the summary of only the one or more particular substeps.

11. The computer-implemented method of claim 10, further comprising summarizing, through the generative model, the workflow based on a summary of a parent step to the particular step.

12. The computer-implemented method of claim 11, further comprising:
recursively summarizing, through the generative model, one or more parent steps to the particular step; and
generating, through the generative model, a summary of the workflow based on a summary of only the one or more particular substeps and the summaries of the one or more parent steps to the particular step.

13. A system comprising:
one or more processors; and
at least one computer-readable storage medium having stored therein instructions which, when executed by the one or more processors, cause the one or more processors to:
obtain a workflow comprising a plurality of steps arranged in an order, wherein at least one step of the plurality of steps comprises a subworkflow having a plurality of substeps arranged in a suborder;
execute an instance of the workflow;
detect an occurrence of a failure in the instance of the workflow;
identify a particular step in the plurality of steps of the workflow associated with the failure;
determine that the particular step comprises a particular subflow;
in response to determining that the particular step comprises a particular subflow, identify one or more particular substeps of the particular subflow that caused the failure; and
generate, through a generative model, a summary of only the one or more particular substeps, wherein the summary is indicative of a cause of the failure.

14. The system of claim 13, wherein the instructions further cause the one or more processors to:
determine if a first substep of the plurality of substeps failed due to failure of a second substep beneath the first substep in the particular subflow; and
identify whether the first substep is a root substep that caused the failure based on whether the first substep failed due to failure of the second substep.

15. The system of claim 14, wherein the instructions further cause the one or more processors to identify that the first substep is the root substep that caused the failure if it is determined that the first substep did not fail due to failure of the second substep.

16. The system of claim 15, wherein the instructions further cause the one or more processors to:
analyze an output of the first substep in response to identifying that the first substep is the root substep;
generate, by the generative model, a summary of the first substep based on the output of the first substep; and
form the summary of only the one or more particular substeps based on the summary of the first substep.

17. The system of claim 14, wherein the instructions further cause the one or more processors to:
determine that the first substep failed due to failure of the second substep;
determine if the second substep failed due to failure of a third substep beneath the second substep; and
identify whether the second substep is the root substep that caused the failure based on whether the second substep failed due to failure of the third substep.

18. The system of claim 17, wherein the instructions further cause the one or more processors to:
generate, by the generative model, a summary of the first substep based on the first substep failing due to failure of the second substep; and
form the summary of only the one or more particular substeps based on the summary of the first substep.

19. The system of claim 13, wherein the instructions further cause the one or more processors to generate, through the generative model, a summary of the workflow based on the summary of only the one or more particular substeps.

20. A non-transitory computer-readable storage medium storing instructions for causing one or more processors to:
obtain a workflow comprising a plurality of steps arranged in an order, wherein at least one step of the plurality of steps comprises a subworkflow having a plurality of substeps arranged in a suborder;
execute an instance of the workflow;
detect an occurrence of a failure in the instance of the workflow;
identify a particular step in the plurality of steps of the workflow associated with the failure;
determine that the particular step comprises a particular subflow;
in response to determining that the particular step comprises a particular subflow, identify one or more particular substeps of the particular subflow that caused the failure; and
generate, through a generative model, a summary of only the one or more particular substeps, wherein the summary is indicative of a cause of the failure.
